(19) United States
(12) Patent Application Publication
(10) Pub. No.: US 2016/0042659 A1
(43) Pub. Date: Feb. 11, 2016

(54) Apparatus and Method for Scheduling and Tracking With Reduced Anxiety

(71) Applicants: Benjamin B. Moelis, Hewlett Harbor, NY (US); Hailey A. Silver, Lynbrook, NY (US); John D. Gebbia, Lynbrook, NY (US); Sarah G. Moelis, Hewlett Harbor, NY (US)

(72) Inventors: Benjamin B. Moelis, Hewlett Harbor, NY (US); Hailey A. Silver, Lynbrook, NY (US); John D. Gebbia, Lynbrook, NY (US); Sarah G. Moelis, Hewlett Harbor, NY (US)

(21) Appl. No.: 14/797,541

(22) Filed: Jul. 13, 2015

Related U.S. Application Data
(60) Provisional application No. 62/024,119, filed on Jul. 14, 2014.

(51) Int. Cl. G09B 19/00; G09B 5/02; G09B 1/02

(52) U.S. Cl. CPC G09B 19/003; G09B 1/02; G09B 5/02

(57) ABSTRACT

An apparatus and method for scheduling and tracking activities with reduced anxiety, especially for autistic users. The apparatus includes a scheduling section with a circle that includes peg holes around its periphery, an overlay that is removably attached to the circle and is dividing into a plurality of segments, with each segment labelled with a task, and each segment aligned with a peg hole. The apparatus also includes peg(s) that fit into each of the plurality of holes, wherein the peg(s) represent completion of a task corresponding to that segment of the overlay. The apparatus also includes an activity and reward section, which includes a customizable activity selector and a customizable reward selector, wherein the selectors allow a user to randomly or purposely select an activity or reward. The apparatus may be implemented as a computer application or as a computing device.

### CROSS REFERENCE TO RELATED APPLICATIONS

This application claims the benefit of, and priority to, U.S. Provisional Application No. 62/024,119 filed on 14 Jul. 2014, which is hereby incorporated by reference in its entirety.

### BACKGROUND

Toys and products currently in the marketplace deal with daily routines and scheduling in a straight-forward, perhaps unimaginative way. Generally, tasks are checked off a list, or stickers are placed next the task when completed.

While such toys and products may be useful for ordinary users, they do not meet the needs of users with autism or Fragile X Syndrome, who inherently have difficulties maintaining schedules, transitioning from one activity to another, and choosing between activities and incentives, because these activities and decisions caused raised anxiety levels.

Accordingly, it is desirable to develop new devices and methods for maintaining schedules and transitioning from one activity to another that provide reduced anxiety levels in users, including and especially autistic users.

### BRIEF DESCRIPTION OF THE DRAWINGS

The accompanying drawings, which are incorporated in and constitute a part of this specification, illustrate embodiments of the invention and together with the description, serve to explain the principles of the invention. In the figures:

FIG. 1 is a perspective view of an exemplary apparatus for scheduling and tracking with reduced anxiety, consistent with the principles of the invention;

FIG. 2 is a top view of an exemplary apparatus for scheduling and tracking with reduced anxiety, consistent with the principles of the invention;

FIG. 3 is another perspective view of an exemplary apparatus for scheduling and tracking including examples of construction details, consistent with the principles of the invention;

FIG. 4 is an illustration of an example of an overlay for the scheduling and tracking device, consistent with the principles of the invention; and

FIGS. 5A-5C are perspective views of an exemplary apparatus for scheduling and tracking in various positions, consistent with the principles of the invention.

### DETAILED DESCRIPTION

Various embodiments consistent with the invention address two issues common in their daily lives of those with autism or Fragile X Syndrome: (1) maintaining schedules; and (2) transitioning from one activity to another without raising anxiety levels. Embodiments consistent with the invention also provide benefits to all users of the disclosed devices and methods, including users with autism or Fragile X Syndrome

Various embodiments consistent with the invention provide a novel way for users to follow the routines or schedule of a day or the order of tasks in an activity contained within that day. Such embodiments treat or present a user's activities and tasks as a game in which the user moves parts around the “board” of the apparatus, thereby visualizing their progress from start to finish as they accomplish each task as part of a fun journey. This approach reduces anxiety.

Various embodiments consistent with the invention also ease a user's anxieties in transitioning from one activity to the next by creating a game-like setting in which the user may position an indicator (e.g., spin an arrow, either intentionally or randomly) to encourage his or her choice and achievement of each new task without creating anxiety. This allows users to make choices that seem like part of a game, as tracked by the device. Due to the reduction or elimination of anxiety related to scheduling and transitioning between daily activities, embodiments consistent with the invention may transform the manner in which users approach their daily lives and help them develop a stronger sense of confidence and adaptability to their environment. This may be especially significant for autistic users.

Reference will now be made in detail to various examples and embodiments of the invention, some of which are illustrated in the accompanying drawings. Wherever convenient, the same reference numbers will be used throughout the drawings to refer to the same or like parts.

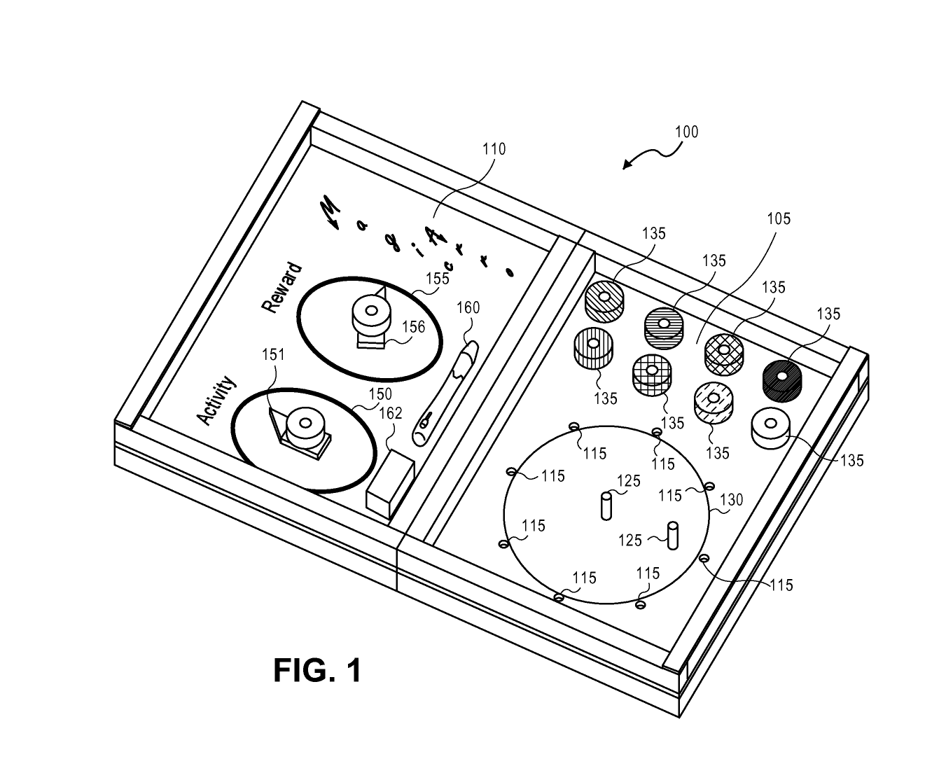

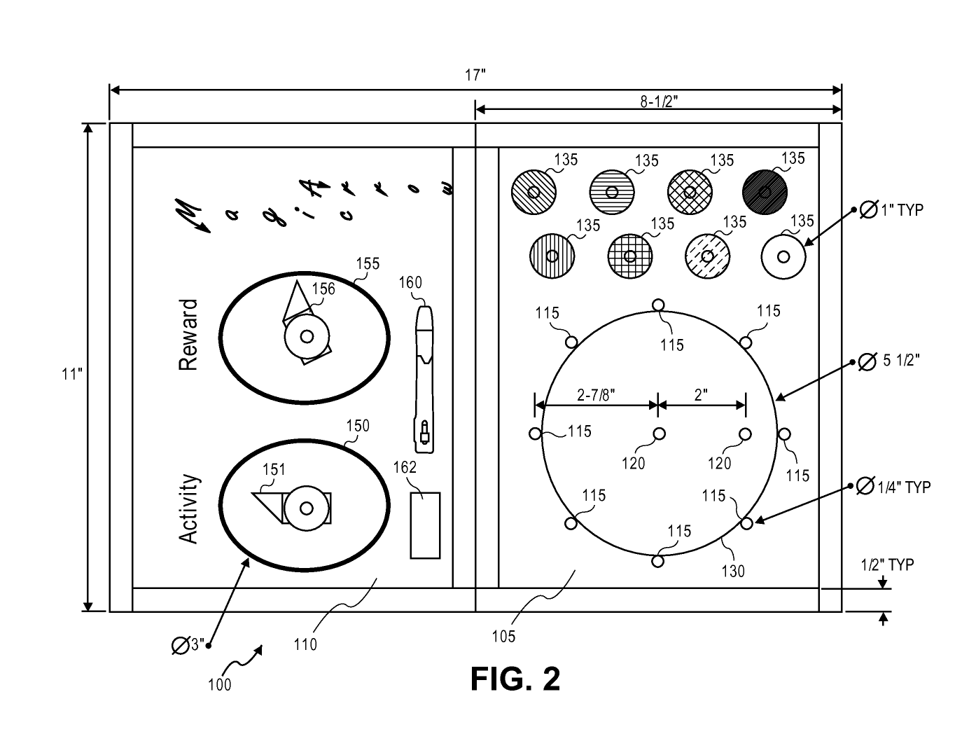

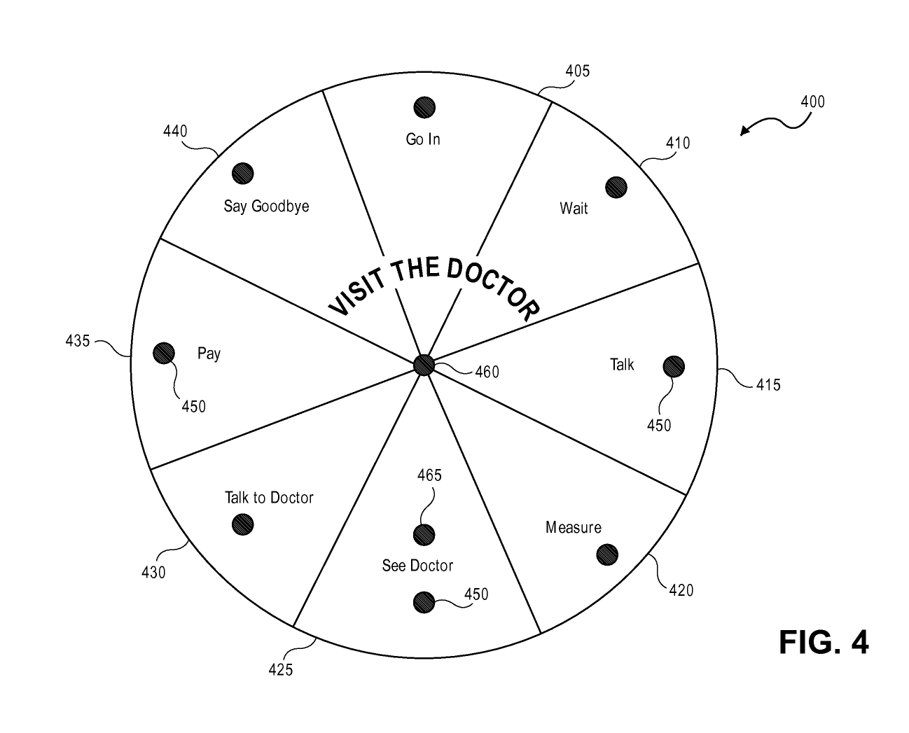

FIG. 1 is a perspective view of an example of an apparatus 100 for scheduling and tracking, consistent with the principles of the invention and FIG. 2 is a top view of the apparatus 100. In the embodiment shown in FIGS. 1 and 2, the apparatus 100 has a tracking side 105 and an activity-reward side 110, each of which may be a plane or plane-like. The tracking side 105 includes features and devices for tracking the parts or segments (e.g., tasks) of a day or the parts of an activity, which together make up a schedule. For example, as shown in FIGS. 1 and 2, a day may be divided into eight parts or segments (e.g., an eight-part schedule for a typical school day) or a single activity within that day may be divided into eight parts or tasks (e.g., an eight-part schedule for bathing) using peg holes 115. In various embodiments, the parts of the day or the activity may be identified using interchangeable overlays (not shown in FIGS. 1-3; see FIG. 4) that cover at least a portion of the tracking side 105 (e.g., the scheduling area defined inside the circle 130) and display depictions of the day's schedule or activities or a particular task or part or segment thereof using, for example, pictures and/or words and/or numbers. In some embodiments, the overlay may be secured to the tracking side 105 using two wooden dowels 125 that are placed in dowel holes 120.

The peg holes 115 may correspond (e.g., align) to the location of each of the eight pieces or segments from the overlays, allowing a user to use the peg(s) 135 as completion indicators for tracking progress along the schedule by either moving a single peg 135 from one hole to the next or placing a different peg 135 into each peg hole 115 until all eight parts, segments, or tasks are completed. In various embodiments, each peg 135 may be differentiated from the others, by for example, color, size, or shape.

In various embodiments, the overlays may be mass-produced or hand-printed circular sheets that cover the circle 130 (e.g., the scheduling area) of the device 100, such as paper or cardstock circles. (See FIG. 4). As noted above, an overlay may include holes corresponding to the dowel holes 120 and an overlay may be secured in the correct alignment on the circle 130 using dowels 125. An overlay may also include holes corresponding to the peg holes 115, so that a user may place a peg 135 through such a hole in the overlay and into a peg hole 115 while the overlay is in place in the scheduling area over the circle 130 in the tracking side 105, which placement may indicate that the task corresponding to the peg hole 115 is completed. The overlay may be divided into various segments, and each segment may include words and/or graphics that represent a task, subtask, sub-activity or the like that a user is performing over time and keeping track of using the device 100.

As noted above and shown in FIG. 2, around the edge of the circle 130 that indicates the scheduling area, eight peg holes 115 correspond to the location (e.g., align) of each pie-piece-shaped segment and eight different pegs 135 are housed outside the circle 130. The users utilizes the overlay, the pegs 135, and the peg holes 115 to schedule and keep track of or measure the progress of their day or tasks or activities by moving a peg 135 from one hole 115 to the next hole 115 around the circle 130 or by placing a different peg 135 in each hole 115 around the circle 130 as an indicator after each activity or task corresponding to each pie-piece segment of the overlay is completed. This allows users either to identify accomplishment of a schedule, or indicate completion of each task with the movement of a particular peg (e.g. favorite color or favorite shape) around the circle 130 and/or to provide a sense of accomplishment as all the peg holes 115 are filled.

The tracking side 105 of the apparatus 100 provides to users a method and device for tracking a schedule or a specific activity or series of tasks in a way that makes the routine or activity fun and game-like. The portions of the overlay on the circle 130 break down each day or activity into a series of achievable tasks or subtasks (e.g., a schedule) and empower the user with a sense of visual accomplishment as each task is completed.

In other embodiments, more or fewer than eight parts, segments, pie-piece-shaped segments, or tasks may used for scheduling and tracking with correspondingly more or fewer numbers of pegs 135 and peg holes 115.

Referring to the left side of the exemplary apparatus 100 in FIGS. 1 and 2, the activity-reward side 110 of the apparatus 100 includes and activity area and a reward area, represented by two circles 150 and 155, labeled “ACTIVITY” and “REWARD”, each with a spinning arrow 151 and 156 fastened in the center. The plane surface of the activity-reward side 110 is a whiteboard surface in this example, which allows things to be drawn, written, and erased from the surface. In the embodiment shown an erasable marker 160 and an eraser 162 are also secured to the activity-reward side 110. Because each user is different, the whiteboard circles 150 and 155 (i.e., the activity area and the reward area) are not permanently divided into portions, sections, segments, or pie slices, giving a user, their caretaker, or their supervisor the option to erasably write any choices, and any number of choices, into separate subdivided portions as they desire in the circles 150 and 155.

An individual (e.g., the user or the user's caretaker) can segment and write in choices of activities and rewards in the appropriate drawn-in portions of the whiteboard circles 150 and 155 depending on their knowledge of the user. The activity-reward side 110 works in conjunction with the tracking side 105 by enabling the user to determine a choice for a particular Activity (e.g., the choice of what is to be eaten during the breakfast activity scheduled by one of the peg holes 115, pegs 135 and overlay (not shown)) by spinning the spinning arrow 151 to select one of a number of drawn-in portions, each having a written-in choice (e.g., pancakes, cereal, toast, etc. for the eat breakfast activity choice). Similarly, the activity-reward side 110 enables the user to determine the Reward for accomplishing an activity (e.g., doing homework, which may be scheduled and tracked by one of the peg holes 115, pegs 135 and appropriate overlay (not shown)) by spinning the spinning arrow 156 to select or determine one of a number of drawn-in portions, each having a written-in reward choice (e.g., the rewards of calling Grandma & Grandpa, having a pretzel snack, playing with the dog, etc.).

In one possible use case, when a user reaches a part or segment of his or her day which includes a choice or decision (e.g., “Do Afternoon Activity,” on the overlay (not shown) of the circle 130, without the activity being pre-specified on the overlay), the user's supervisor may used the erasable marker 160 to subdivide and write in choices in the ACTIVITY area 150 that give the user the ability to choose or select one amongst several afternoon activities (e.g., watch TV, play with a toy) by spinning the spinning arrow 151 so that it points to a portion containing one of the written-in choices. Similarly, when a user reaches a part of his or her day which includes a reward, the user's supervisor may used the erasable marker 160 to subdivide and write in possible reward choices in the REWARD area 155 and then give the user the ability to choose or select one amongst several rewards (e.g., pretzels, call Grandma & Grandpa, etc.) by spinning the spinning arrow 156 so that it points to one of the choices. The spinning may be random, or it the spinning arrow 156 may be purposely placed by the user to indicate (point to) a specific choice. In doing so, users expressly make choices while subtly easing the anxiety in the decision making and in transitioning from one activity to another because the device 100 provides a game-like mechanism for decision making.

The activity-reward side 110 of the apparatus 100 provides to users a method and device for addressing and soothing a user's anxieties that stem from making choices or transitioning from one task to another. The activity-reward side 110 may be especially beneficial to users who are more anxious with decision-making or for whom easing anxieties is part of that user's occupational therapy, such as autistic users.

Thus, various embodiments consistent with the principles of the invention may employ the tracking side 105 and the activity-reward side 110 to provide to users a fun and game-like way to schedule and move through the tasks of their day while encouraging them via activities and rewards to make choices without heightening their anxieties.

The embodiment shown in FIG. 2 includes examples of dimensions for one implementation of consistent with the invention. The exact dimensions are not critical to the invention and different dimensions may be used within the principles of the invention.

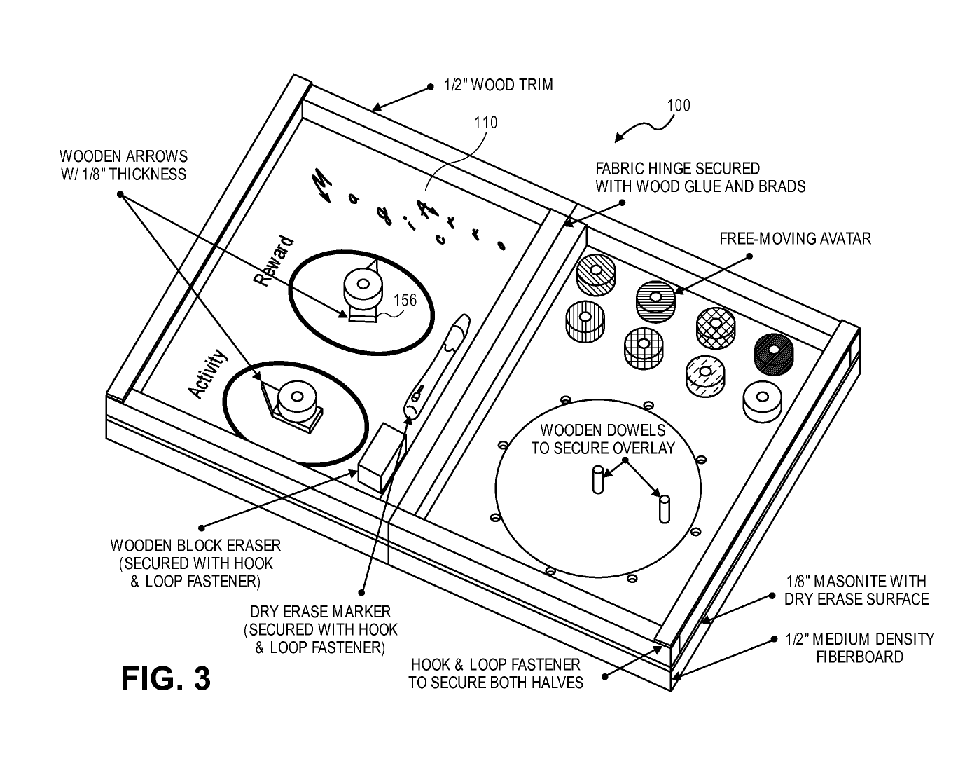

FIG. 3 is another perspective view of an example of an apparatus 100 for scheduling and tracking including examples of construction details, consistent with the principles of the invention. In the example shown, the apparatus 100 is constructed primarily from wood, fiberboard, fabric and dry-erase Masonite™. Other embodiments may be constructed using other materials, for example, the fabric hinge shown in this example may be replaced with a metal hinge or hinges.

FIG. 4 is an illustration of an example of an overlay 400 for the scheduling and tracking device 100, consistent with the principles of the invention. In various embodiments, the overlays may be plastic-coated, cardstock circles divided into eight segments 405-440 corresponding to the positions of the peg holes 115, including holes 450 through the overlay 400 that align with the peg holes 115 of the device 100. As shown, an overlay may also have holes 460, 465 that that align with the dowel holes 120 of the device 100, such that the dowels 125 secure the overlay 400 into place in the proper alignment on the device 100.

Each segment 405-440 may include pictures and/or words describing scheduled tasks, subtasks, sub-activities, or the like. In the example of an overlay shown, the overlay 400 is divided into eight activities or tasks that occur during or that make up a doctor's visit. Segment 405 represents the activity “Go In” to the doctor's office. Segment 410 represents the activity “Wait” in the waiting room. Segment 415 represents the activity “Talk” to the nurse when the nurse calls you in from the waiting room. Segment 420 represents the activity “Measure” your height. Segment 425 represents the activity “See Doctor” for your checkup. Segment 430 represents the activity “Talk to Doctor” after he or she examines you. Segment 435 represents the activity “Pay” the doctor. And, segment 440 represents the activity “Say Goodbye” to the staff as you leave. Although not shown in FIG. 4, each segment may include graphics illustrating its task, in addition to the words. For example, the “Go In” segment 405 may include a picture or drawing of a person walking in the door of a building; the “Wait” segment 410 may include a picture or drawing of a person sitting in a chair under a clock; the “Talk” segment 415 may include a picture or drawing of a person talking to a nurse; and the like.

For another example of an overlay for a schedule or plan having eight sub-activities or tasks, consider a typical school day for a child. A “Typical School Day” schedule overlay (not shown) may feature eight “pie pieces,” segments, or portions, each representing tasks that include: 1) Get Up & Get Dressed; 2) Eat Breakfast; 3) Go To School; 4) Come Home & Do Homework; 5) Do Afternoon Activity; 6) Eat Dinner; 7) Do Evening Activity; and 8) Bathe & Get Ready For Bed. As noted above, an overlay may include holes corresponding to the dowel holes 120 and an overlay may be secured in the correct alignment on the circle 130 using dowels 125. Also as noted above, an overlay may be divided into, and used to schedule and track, fewer or more than eight activities or tasks, in various implementations.

Further, embodiments consistent with the principles of the invention are not limited to physical embodiments. Embodiments consistent with the principles of the invention include virtual embodiments which are implemented, displayed, and interacted with on a computing system, such as a client-server system, laptop computer, tablet computer, smartphone, etc. A software application implementation for a tablet computer, such as an Apple iPad™ or a Kindle Fire™ or the like, may be particularly desirable because these devices are very portable, allowing a user to easily carry and utilize the application throughout their day. In such virtual embodiments, a graphical user interface may simulate the features shown in FIGS. 1-3, and a user may be able to change overlays, write in and customize activities and rewards, select activities and rewards (e.g., spin a virtual arrow), move pegs into and out of peg holes (or use like completion indicators), etc. by manipulating corresponding virtual visual objects on the graphical user interface.

For example, a computer-implemented version of the device 100 may include a graphical user interface that mimics the view of device 100 shown in FIG. 2 with the overlay 400 of FIG. 4 in place. Such an implementation may include virtual controls that allow a user to select one from among a group of virtual overlays, which are similar to overlay 400, to place over the scheduling area delimited by the circle 130, and drag and drop virtual pegs 135 into virtual peg holes 115 as tasks are completed to indicate their completion. In other implementations, techniques other than virtual pegs 135 may be used to track tasks on a virtual overlay, such as having a user double click on a segment of the virtual overlay to make it change color to indicate that the user has completed the task.

Similarly, a computer implementation of the activity-reward side 110 may utilize a touch screen of a computing device, such as a tablet computer, to allow a user or caretaker to erasable subdivide and write activities into an activity area denoted by circle 150 and rewards into a reward area denoted by circle 155 using their finger, in a manner similar to that described above with respect to a white board and erasable marker implementation. Similarly, the graphical interface of a computer implementation may include virtual spinning arrows 151 and 156, which a user can virtually spin by swiping a finger across the virtual arrow on the touch screen of the computing device. Other computer-implemented variations are also possible.

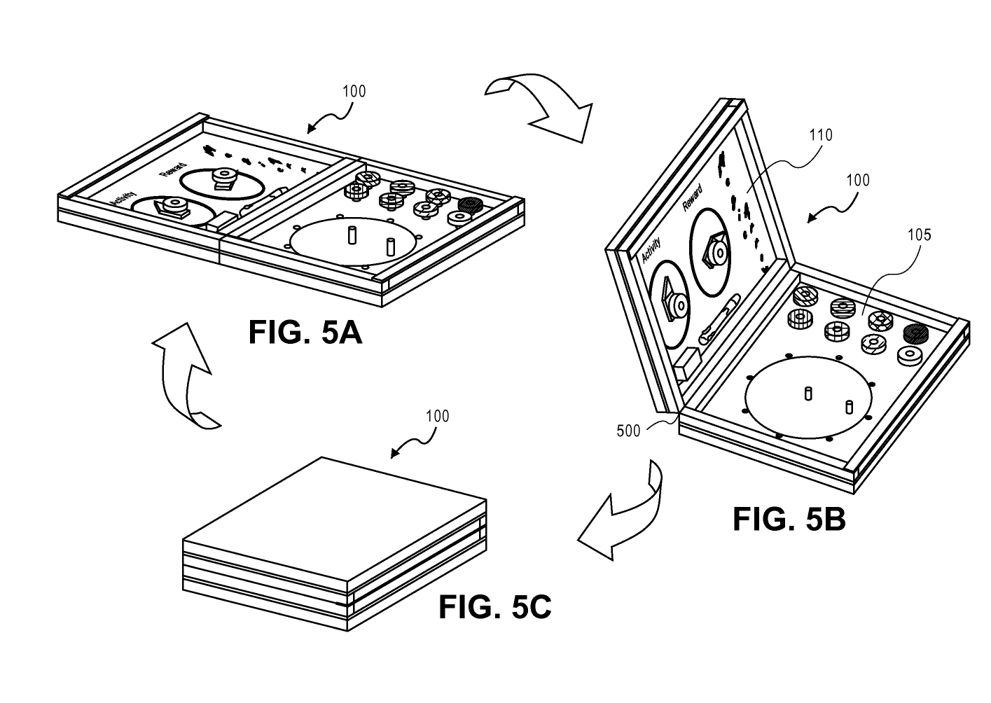

FIGS. 5A-5C are perspective views of an example of an apparatus 100 for scheduling and tracking in various positions, consistent with the principles of the invention. In the example shown, the apparatus 100 is implemented in the form of an opening and closing compact box. In some embodiments, the apparatus 100 may be similar in size to a portable backgammon set or a small lap-top computer. Such embodiments may allow for easy mobility when traveling and may give users the emotional sense that they are in charge of their daily lives, their routines, and their activities and tasks within each day, thus reducing anxiety.

FIG. 5A depicts the apparatus 100 for scheduling and tracking in a fully open position, in which position it may be employed by users and caretakers as described herein. FIG. 5B depicts the apparatus 100 for scheduling and tracking in a semi-close position, wherein the tracking side 105 and the activity-reward side 110 are pivoting toward each other around the hinge line 500 between them. FIG. 5C depicts the apparatus 100 for scheduling and tracking in a fully closed position. In various embodiments, a latch (not shown) may be employed to secure the apparatus 100 in the fully closed position. Some embodiments may include a handle (not shown) for carrying in the closed position. In various embodiments, the pegs 135 and spinning arrows 151 and 156 may be secured in or prevented from falling out of their current holes by the opposing side when the apparatus 100 is in the fully closed position; while in other embodiments, friction fits between the pegs, dowels, and arrows and their respective holes may prevented items from falling out in the closed position.

Other embodiments of the invention will be apparent to those skilled in the art from consideration of the specification and practice of the invention disclosed herein, including computer-implemented embodiments as mentioned previously. It is intended that the specification and examples be considered as exemplary only, with a true scope and spirit of the invention being indicated by the claims of a corresponding non-provisional application that will be filed in the future. The claims described below are possible examples.

What is claimed is:

1. An apparatus comprising:
a first plane having a plurality of holes arranged in a circle;
an overlay that is divided into a plurality of segments, wherein each segment of the plurality of segments is labelled with a task, and wherein the overlay is removably attached to the first plane such that each segment of the plurality of segments aligns with a hole of the plurality of holes;
a peg that fits into each hole of the plurality of holes, wherein the peg is movable among each hole the plurality of holes to represent completion of the task of the segment that aligns with each hole of the plurality of holes.

2. The apparatus of claim 1 further comprising:
a second plane having a markable and erasable surface and having an activity area; and
a first indicator attached to the second plane for selecting a portion of the activity area;
wherein the first indicator is activated by a user to select an activity from among a plurality of activities that are erasably marked in a plurality of portions of the activity area.

3. The apparatus of claims 1, further comprising
a second plane having a markable and erasable surface and having a reward area; and
a second indicator attached to the second plane for selecting a portion of the reward area;
wherein the second indicator is activated by a user to select a reward from among a plurality of rewards that are erasably marked in a plurality of portions of the reward area.

4. The apparatus of claims 2, wherein the second plane comprises:
a reward area; and
a second indicator attached to the second plane for selecting a portion of the reward area;
wherein the second indicator is activated by a user to select a reward from among a plurality of rewards that are erasably marked in a plurality of portions of the reward area.

5. The apparatus of claim 1, further comprising:
a plurality of pegs, each of which fits into each of the plurality of holes.

6. The apparatus of claim 5, wherein the plurality of pegs are each different.

7. A non-transitory computer-readable medium including instructions that when executed by a process, perform operations for scheduling and tracking tasks for a user, the operations comprising:
displaying a plane-like tracking area having a scheduling area;
displaying a user-selectable overlay in the scheduling area, wherein the user-selectable overlay is divided into a plurality of segments, wherein each segment of the plurality of segments is labelled with a task, and wherein the user-selectable overlay is replaceable with another user-selectable overlay;
displaying a user-activated completion indicator; and
accepting input from the user to control the completion indicator to represent completion of the task of a segment of the overlay.

8. The non-transitory computer-readable medium of claim 7, the operations further comprising:
displaying a second plane-like area having an activity area;
accepting input from the user to subdivide the activity area into a plurality of portions and to label each portion of the plurality of portions;
displaying a first indicator in the activity area for selecting a single portion of the activity area;
accepting input from the user to activate the first indicator and select a single portion of the activity area.

9. The non-transitory computer-readable medium of claim 8, wherein the first indicator randomly selects a single portion of the activity area when activated by the user.

10. The non-transitory computer-readable medium of claim 8, the operations further comprising:
displaying a reward area in the second plane-like area;
accepting input from the user to subdivide the reward area into a plurality of portions and to label each portion of the plurality of portions;
displaying a second indicator in the reward area for selecting a single portion of the reward area;
accepting input from the user to activate the second indicator and select a single portion of the reward area.

11. The non-transitory computer-readable medium of claim 10, wherein the second indicator randomly selects a single portion of the reward area when activated by the user.

12. The non-transitory computer-readable medium of claim 7, the operations further comprising:
displaying a plurality of user-activated completion indicators, wherein the plurality of user-activated completion indicators are controllable by the user to represent completion of the tasks of the plurality of segments of the user-selectable overlay.

13. The non-transitory computer-readable medium of claim 12, wherein the plurality of user-activated completion indicators are each different.

14. A computing device for scheduling and tracking tasks for a user, the computing device comprising:
a memory containing instructions; and
a processor, operably connected to the memory, that executes the instructions to perform operations comprising:
displaying a plane-like tracking area having a scheduling area;
displaying a user-selectable overlay in the scheduling area, wherein the user-selectable overlay is divided into a plurality of segments, wherein each segment of the plurality of segments is labelled with a task, and wherein the user-selectable overlay is replaceable with another user-selectable overlay; and
displaying a user-activated completion indicator; and
accepting input from the user to control the completion indicator to represent completion of the task of a segment of the overlay.

15. The computing device of claim 14, the operations further comprising:
displaying a second plane-like area having an activity area;
accepting input from the user to subdivide the activity area into a plurality of portions and to label each portion of the plurality of portions;
displaying a first indicator in the activity area for selecting a single portion of the activity area;
accepting input from the user to activate the first indicator and select a single portion of the activity area.

16. The computing device of claim 15, wherein the first indicator randomly selects a single portion of the activity area when activated by the user.

17. The computing device of claim 15, the operations further comprising:
displaying a reward area in the second plane-like area;
accepting input from the user to subdivide the reward area into a plurality of portions and to label each portion of the plurality of portions;
displaying a second indicator in the reward area for selecting a single portion of the reward area;
accepting input from the user to activate the second indicator and select a single portion of the reward area.

18. The computing device of claim 17, wherein the second indicator randomly selects a single portion of the reward area when activated by the user.

19. The computing device of claim 14, the operations further comprising:
displaying a plurality of user-activated completion indicators, wherein the plurality of user-activated completion indicators are controllable by the user to represent completion of the tasks of the plurality of segments of the user-selectable overlay.

20. The computing device of claim 19, wherein the plurality of user-activated completion indicators are each different.
